(19) United States
(12) Patent Application Publication
(10) Pub. No.: US 2023/0153602 A1
(43) Pub. Date: May 18, 2023

(54) CASCADING META LEARNER TO ENHANCE FUNCTIONALITIES OF MACHINE LEARNING MODELS

(71) Applicant: Capital One Services, LLC, McLean, VA (US)

(72) Inventors: Anh Truong, Champaign, IL (US); Austin Walters, Savoy, IL (US); Jeremy Goodsitt, Champaign, IL (US)

(21) Appl. No.: 17/526,617

(22) Filed: Nov. 15, 2021

(51) Int. Cl. G06N 3/08; G06N 20/00

(52) U.S. Cl. CPC G06N 3/08; G06N 20/00

(57) ABSTRACT

Systems as described herein may cascade a meta learner to enhance functionalities of machine learning models. A cascading server may convert a first machine learning model to a neural network machine learning model. The cascading server may use an embedding machine learning model to extract metadata from a plurality of data records. The cascading server may generate a first set of feature vectors using the converted neural network machine learning model, and generate a second set of feature vectors using the embedding machine learning model. The cascading sever may concatenate the first set of feature vectors with the second set of feature vectors to generate concatenated feature vectors. Accordingly, the cascading server may train a combined machine learning model using the concatenated feature vectors and the trained combined machine learning model may enhance performance of the first machine learning model.

### FIELD OF USE

Aspects of the disclosure relate generally to big data and more specifically to the processing of big data using machine learning models.

### BACKGROUND

An enterprise may implement various proprietary machine learning models to process big data appropriate for the enterprise. In building, managing and evaluating machine learning workflows, a massive amount of data may be collected and annotated, so that the collected data may be analyzed by the machine learning models. However, these proprietary machine learning models may not take advantage of metadata related to the collected data at the times when the models were built. As a result, the performance of the machine learning models may suffer. This may limit the enterprise’s ability to use machine learning models to provide predictions, insights, and forecasts.

Aspects described herein may address these and other problems, and generally improve the performance, accuracy and efficiency of processing big data using machine learning models.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below. Corresponding apparatus, systems, and computer-readable media are also within the scope of the disclosure.

Systems as described herein may include features for cascading a meta learner to enhance the functionalities of machine learning models. A cascading system may process a plurality of data records using a first machine learning model. The first machine learning model may not be a neural network machine learning model. For example, the first machine learning model may be a decision tree model. The cascading system may convert the first machine learning model to a neural network machine learning model. The neural network machine learning model may include, for example, a fully connected neural network (FCNN), a convolutional neural network (CNN), a recurrent neural network or a feed forward neural network. The cascading system may extract metadata associated with the plurality of data records using an embedding machine learning model. The embedding machine learning model may include, for example, an autoencoder, a variational autoencoder (VAE), a Bert Model or a transformer model. The cascading system may use the plurality of data records as input to generate a first set of feature vectors via the converted neural network machine learning model. The cascading system may use the metadata as input to generate a second set of feature vectors via the embedding machine learning model. The cascading system may concatenate the first set of feature vectors with the second set of feature vectors to generate concatenated feature vectors. The cascading system may generate a combined machine learning model based on the neural network machine learning model and the embedding machine learning model. The cascading system may use the concatenated feature vectors as input to train the combined machine learning model. Accordingly, the trained combined machine learning model may enhance performance of the first machine learning model.

These features, along with many others, are discussed in greater detail below.

### BRIEF DESCRIPTION OF THE DRAWINGS

The present disclosure is described by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2 depicts an example deep neural network architecture for a model according to one or more aspects of the disclosure;

FIG. 3 depicts a system comprising different computing devices that may be used in implementing one or more aspects of the disclosure in accordance with one or more illustrative aspects discussed herein;

FIG. 4 depicts example machine learning models according to one or more aspects of the disclosure; and

FIG. 5 shows a flow chart of a process for cascading a meta learner to enhance the functionalities of machine learning models according to one or more aspects of the disclosure.

### DETAILED DESCRIPTION

In the following description of the various embodiments, reference is made to the accompanying drawings, which form a part hereof, and in which is shown by way of various illustrative embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. In addition, it is to be understood that the phraseology and terminology used herein are for the purpose of description and should not be regarded as limiting. Rather, the phrases and terms used herein are to be given their broadest interpretation and meaning.

By way of introduction, aspects discussed herein may relate to methods and techniques for cascading a meta learner to enhance the functionalities of machine learning models. The cascading system may receive a plurality of data records in a first data format, and convert the plurality of data records from the first data format to a second data format. The cascading system may use the first machine learning model to generate a plurality of prediction labels based on the plurality of data records in the second data format. For example, the data records may include transaction records, and the predicted labels may include an indication whether the transaction records contain sensitive data or whether the transactions are fraudulent. The metadata may comprise column names, data sources, table names, and correlation between features that are associated with the plurality of data records. The metadata may comprise a mean, a variance, a range or a length associated with a column in the plurality of data records.

In many aspects, the cascading system may train the converted neural network machine learning model to be a proxy to the first machine learning model. The cascading system may train the converted neural network machine learning model based on the plurality of data records and the plurality of prediction labels. The cascading system may provide, as input to a classification layer, the concatenated feature vectors. The classification layer may be a meta learner associated with a combined machine learning model. The cascading system may receive, as output from the classification layer and based on the concatenated feature vectors, a plurality of new prediction labels associated with the plurality of data records. The cascading system may compare the plurality of prediction labels with the plurality of new prediction labels, and train the combined machine learning model based on the comparison.

Aspects described herein improve the functioning of computers by improving the accuracy and security of computer-implemented authentication processes. The steps described herein recite improvements to computer-implemented authentication processes, and in particular improve the accuracy and performance of machine learning models. This is a problem specific to computer-implemented processes, and the processes described herein could not be performed in the human mind (and/or, e.g., with pen and paper). For example, as will be described in further detail below, the processes described herein rely on the processing of big data including transaction data, and the use of various machine learning models.

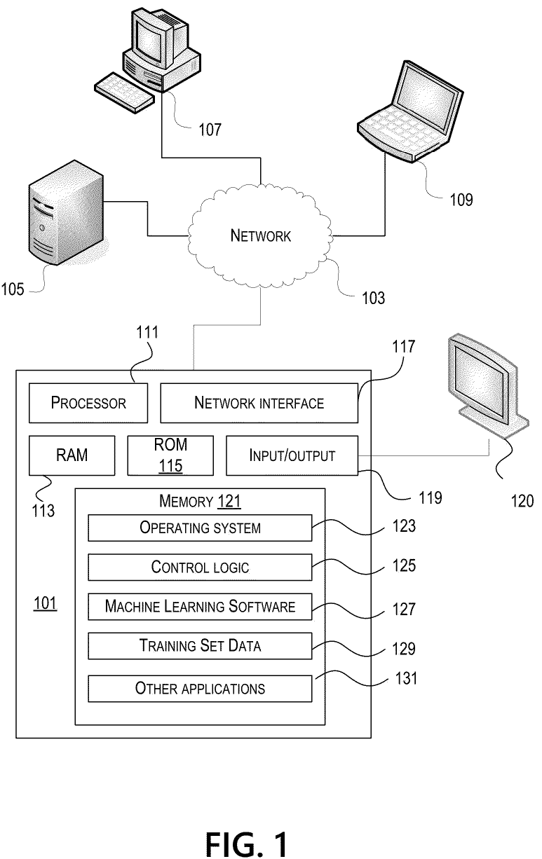

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading and/or executing instructions and performing one or more actions based on the instructions. In some embodiments, computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing device 101 may, in some embodiments, operate in a standalone environment. In others, computing device 101 may operate in a networked environment. As shown in FIG. 1, computing devices 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topology and may use one or more of a variety of different protocols, such as Ethernet. Computing devices 101, 105, 107, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces (I/O) 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, machine learning software 127, and training set data 129. Control logic 125 may be incorporated in and may be a part of machine learning software 127. In other embodiments, computing device 101 may include two or more of any and/or all of these components (e.g., two or more processors, two or more memories, etc.) and/or other components and/or subsystems not illustrated here.

Computing devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QoS), etc. For example, computing devices 101, 105, 107, 109, and others may operate in concert to provide parallel computing features in support of the operation of control logic 125 and/or machine learning software 127.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

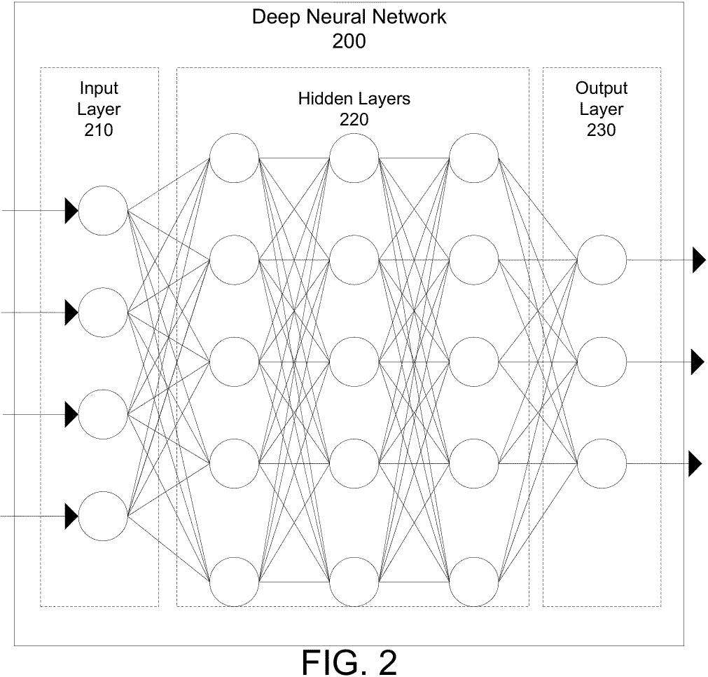

FIG. 2 illustrates an example deep neural network architecture 200. Such a deep neural network architecture might constitute all or portions of the machine learning software 127 shown in FIG. 1. That said, the architecture depicted in FIG. 2 need not be performed on a single computing device, and might be performed by, e.g., a plurality of computers (e.g., one or more of the computing devices 101, 105, 107, 109). An artificial neural network may be a collection of connected nodes, with the nodes and connections each having assigned weights used to generate predictions. Each node in the artificial neural network may receive input and generate an output signal. The output of a node in the artificial neural network may be a function of its inputs and the weights associated with the edges. Ultimately, the trained model may be provided with input beyond the training set and used to generate predictions regarding the likely results. Artificial neural networks may have many applications, including object classification, image recognition, speech recognition, natural language processing, text recognition, regression analysis, behavior modeling, and others.

An artificial neural network may have an input layer 210, one or more hidden layers 220, and an output layer 230. A deep neural network, as used herein, may be an artificial network that has more than one hidden layer. Illustrated network architecture 200 is depicted with three hidden layers, and thus may be considered a deep neural network. The number of hidden layers employed in deep neural network 200 may vary based on the particular application and/or problem domain. For example, a network model used for image recognition may have a different number of hidden layers than a network used for speech recognition. Similarly, the number of input and/or output nodes may vary based on the application. Many types of deep neural networks are used in practice, such as convolutional neural networks, recurrent neural networks, feed forward neural networks, combinations thereof, and others.

During the model training process, the weights of each connection and/or node may be adjusted in a learning process as the model adapts to generate more accurate predictions on a training set. The weights assigned to each connection and/or node may be referred to as the model parameters. The model may be initialized with a random or white noise set of initial model parameters. The model parameters may then be iteratively adjusted using, for example, stochastic gradient descent algorithms that seek to minimize errors in the model.

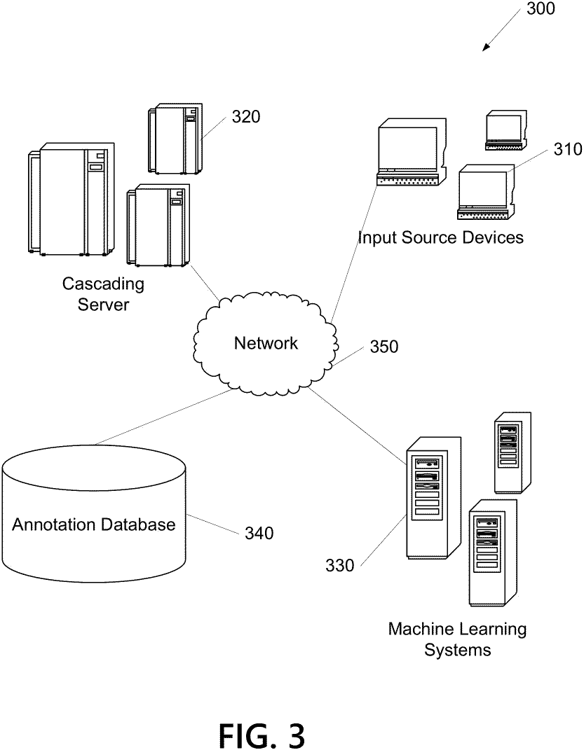

FIG. 3 shows a cascading system 300. The cascading system 300 may include at least one input source device 310, at least one cascading server 320, one or more machine learning systems 330, and/or at least one annotation database 340 all interconnected via a network 350. It will be appreciated that the network connections shown are illustrative and any means of establishing a communications link between the computers may be used. The existence of any of various network protocols such as TCP/IP, Ethernet, FTP, HTTP and the like, and of various wireless communication technologies such as GSM, CDMA, WiFi, and LTE, is presumed, and the various computing devices described herein may be configured to communicate using any of these network protocols or technologies. Any of the devices and systems described herein may be implemented, in whole or in part, using one or more computing systems described with respect to FIG. 1.

Input source device 310 may be any device capable of obtaining data records that contain a collection of text, some of which may represent transaction data. For example, the collection of text may be related to a transaction record containing confidential financial data, such as an account identifier, the transaction time, transaction amount, and a merchant name. The collection of text may be related to comments or feedback of a service provided by a financial institution or other service provider that may be potentially embarrassing if it were to be divulged to a third-party. The collection of text may include personnel information, such as performance reviews that may be sensitive or confidential. The collection of text may also be related to documents reviewed during a litigation process that may be confidential or privileged and may not be disclosed to a third-party. Input source devices 310 may include scanner, a camera, camera-arrays, camera-enabled mobile-devices, etc. Alternatively, input sources may include computing devices, such as laptop computers, desktop computers, mobile devices, smart phones, tablets, and the like. According to some examples, input sources may include hardware and software that allow them to connect directly to network 350. Alternatively, input source devices 310 may connect to a local device, such as a personal computer, server, or other computing device, which connects to network 350. In some embodiments, input source devices 310 may include a scanner associated with an automated teller machine (ATM). The scanner may be configured to scan checks, certificates of deposit, money orders, and/or currency. In other embodiments, the input source 310 may be a scanner located at a branch location. The scanner may be configured to scan documents, such as loan and/or credit applications, and securely transmit the documents to a central location, such as a head office or a central banking location, for further processing.

Cascading system 320 may collect, parse, and/or store documents containing data records. The documents may be stored as unstructured data from various input sources which may include books, journals, metadata, health records, audio, video, analog data, images, files, and/or unstructured text, such as the body of an e-mail message, Web page, or word-processor document. For example, cascading system 320 may extract content and/or data from a content website automatically using a bot or web scraper. Cascading system 320 may access the content website using a web protocol, such as Hypertext Transfer Protocol (HTTP), or through a web browser. Cascading system 320 may obtain a data dump from the content sources and store the data in a corpus database (not shown in FIG. 3). The corpus database may also be part of annotated database 340. Cascading system 320 may copy or collect unstructured data in a text format from the web, convert the data into a common format, such as a JavaScript Object Notation (JSON) format, a comma-separated values (CSV) format or an Extensible Markup Language (XML) format. Cascading system 320 may store the documents containing confidential data in the corpus database for later retrieval or analysis.

Cascading server 320 may retrieve the documents containing the data records from the corpus database or receive the documents from input source devices 310. Cascading server 320 may parse collections of text in the documents to identify keywords and/or confidential data. Cascading server 120 may filter certain stop words from the text, such as “that,” “the,” “are,” “to” and the like, to adjust for the fact that some words may appear more frequently, but carry less weight. Cascading server 320 may filter the stop words using, for example, term frequency-inverse document frequency (TFIDF), which may be a numerical statistic model that may reflect how important a word is to a document in a collection or corpus.

Cascading server 320 may convert a document containing the data records into text embeddings based on a collection of text in the document. Cascading server 320 may subsequently input the text embeddings to machine learning systems 330 for annotation. Machine learning systems 330 may be on a computing system separate from cascading server 320. Alternatively, machine learning systems 330 may be a component of cascading server 320 (not shown in FIG. 3). Machine learning systems 330 may include one or more proprietary machine learning models. The proprietary machine learning models may be traditional machine learning models such as a decision tree model, a standard normal variate (SNV) model, a support vector machine (SVM) model or a random forest model. Machine learning system 330 may include one or more neural network machine learning models. The neural network machine learning model may have the deep neural network architecture 200 as illustrated in FIG. 2. The neural network machine learning model may include, such as, a fully connected neural network (FCNN), a convolutional neural network (CNN), a recurrent neural network, or a feed forward neural network. Machine learning systems 330 may include one or more embedding machine learning models. The embedding machine learning models may include, such as, an autoencoder, a variational autoencoder (VAE), a Bert Model or a transformer model.

Cascading server 320 may provide the data records as input to the traditional machine learning model. Cascading server 320 may receive a plurality of predicted labels from the traditional machine learning model. Cascading server 320 may convert the traditional machine learning model into a neural network machine learning model. The converted neural network machine learning model may be trained to be a proxy to the traditional machine learning model. For example, the converted neural network machine learning model may generate predicted labels similar to that produced by the traditional machine learning model, based on the same data records as input. Cascading server 320 may extract metadata associated with the data records using an embedding machine learning model. For example, the data records may include one or more columns corresponding to a social security number (SNN), an account number, a phone number, a transaction amount, etc. The predicted labels may indicate whether the columns contain sensitive data (e.g., whether column 1 SSN contains sensitive data). The metadata may be implicit information such as statistics on the columns including a mean, a variance, a minimal or maximal value, a standard deviation, a histogram, a range or length associated with a column, summary information for one or more of the columns, correlations between two columns, or inferred names for the columns.

Cascading server 320 may generate a first set of feature vectors using the data records as input and via the converted neural network machine learning model. Cascading server 320 may generate a second set of feature vectors using the metadata as input and via the embedding machine learning model. For example, a first set of feature vectors may include a 200-dimension vector, and a second set of feature vectors may include a 100-dimension vector. Cascading server 320 may concatenate the first set of feature vectors with the second set of feature vectors to generate concatenated feature vectors. For example, the concatenated feature vectors may include a 300-dimension vector. Cascading server 320 may generate a combined machine learning model based on the neural network machine learning model and the embedding machine learning model. Cascading server 320 may use the concatenated feature vectors as input to train the combined machine learning model. The trained combined machine learning model may be used to annotate data records and enhance performance of the traditional machine learning model.

Cascading server 320 may use the trained combined machine learning model to generate labels for the data records. For example, the data records may include a collection of text that may be labeled based on whether the text contains confidential information. Cascading server 120 may send the labels with the corresponding embeddings, text and documents into annotated database 140 for storage. A document may correspond to a plurality of labels, which may be matched back to certain portions of the original documents. The mapping between a label and a corresponding portion of the original document may be stored in annotated database 340.

Annotated database 340 may store documents (e.g., confidential data) and their corresponding labels. For example, annotated database 340 may store transaction records related to transactions previously conducted by users in transaction streams from customers of a financial institution. The transaction records may each contain an account identifier, a transaction amount, a transaction time and a merchant identifier. A transaction record may be stored with a label, such as class 1 or class 0, where class 1 may correspond to non-fraudulent transactions and class 0 may correspond to fraudulent transactions. In another example, annotated database 340 may store comments or feedback from customers related to a service provided by a financial institution or other service providers. For example, a record in annotated database 340 may include a record identifier, a customer identifier, a comment field related to feedback on a service provided, and a label such as a negative or positive to indicate the nature of the customer experience with the service.

Cascading server 320 may later retrieve the labeled documents containing confidential data and send the labeled documents to a computing device (not shown) to provide insights to the confidential data to facilitate tasks related to, for example, credit decisioning process and fraud detection logic. For example, the computing device may be a server in a financial institution that processes loan and/or credit applications. Based on the label indicating the related transaction being fraudulent or non-fraudulent, the computing device may approve or deny the applications.

Input source devices 310, cascading server 320, machine learning systems 330, and/or annotated database 340 may be associated with a particular authentication session. Cascading server 320 may receive, process, and store a variety of data records and other confidential information, and/or receive data records from input source devices 310 as described herein. However, it should be noted that any device in cascading system 300 may perform any of the processes and/or store any data as described herein. Some or all of the data described herein may be stored using one or more databases. Databases may include, but are not limited to relational databases, hierarchical databases, distributed databases, in-memory databases, flat file databases, XML databases, NoSQL databases, graph databases, and/or a combination thereof. The network 180 may include a local area network (LAN), a wide area network (WAN), a wireless telecommunications network, and/or any other communication network or combination thereof.

The data transferred to and from various computing devices in cascading system 300 may include secure and sensitive data, such as confidential documents, customer personally identifiable information, and account data. Therefore, it may be desirable to protect transmissions of such data using secure network protocols and encryption, and/or to protect the integrity of the data when stored on the various computing devices. A file-based integration scheme or a service-based integration scheme may be utilized for transmitting data between the various computing devices. Data may be transmitted using various network communication protocols. Secure data transmission protocols and/or encryption may be used in file transfers to protect the integrity of the data such as, but not limited to, File Transfer Protocol (FTP), Secure File Transfer Protocol (SFTP), and/or Pretty Good Privacy (PGP) encryption. In many embodiments, one or more web services may be implemented within the various computing devices. Web services may be accessed by authorized external devices and users to support input, extraction, and manipulation of data between the various computing devices in cascading system 300. Web services built to support a personalized display system may be cross-domain and/or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. Secure network appliances may include built-in features such as hardware-accelerated SSL and HTTPS, WS-Security, and/or firewalls. Such specialized hardware may be installed and configured in cascading system 300 in front of one or more computing devices such that any external devices may communicate directly with the specialized hardware.

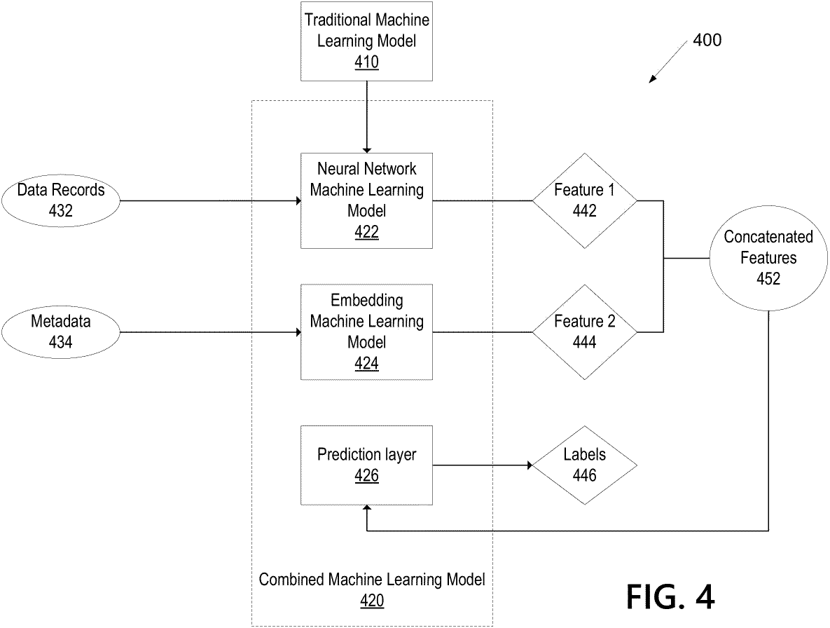

FIG. 4 depicts example machine learning models according to one or more aspects of the disclosure. As illustrated in FIG. 4, system 400 may include traditional machine learning model 410, and combined machine learning model 420, which may in turn include neural network machine learning model 422, embedding machine learning model 424 and prediction layer 426. Traditional machine learning model 410 may be converted to neural network machine learning model 422, which may be a proxy to traditional machine learning model 410. Traditional machine learning model 410 may be one or more proprietary or existing machine learning models developed by an organization suitable for processing big data within the organization. The proprietary machine learning models may include machine learning models such as a decision tree model, an SNV model, an SVM model or a random forest model. Neural network machine learning model 422 may have the deep neural network architecture 200 as illustrated in FIG. 2. Neural network machine learning model 422 may include, for example, a FCNN, a CNN, a recurrent neural network, or a feed forward neural network. Embedding machine learning model 424 may include, for example, an autoencoder, a VAE, a Bert Model or a transformer model.

A cascading server (not shown in FIG. 4) may provide data records as input to neural network machine learning model 422 and generate feature 1 442. The cascading server may provide metadata as input to embedding machine learning model 424 and generate feature 2 444. The cascading server may concatenate feature 1 422 and feature 2 444 to generate concatenated features 452. Subsequently, the cascading server may provide concatenated features 452 as input to prediction layer 426 of combined machine learning model 420, and generate labels 446. Combined machine learning model 420 may have enhanced performance compared to that of traditional machine learning model 410.

As noted above, an organization may acquire data records, sensitive data and/or confidential information about users via documents, forms, etc. Machine learning models may be used to analyze those documents to identify the data and/or information contained in these documents, forms, etc. Additionally or alternatively, machine learning models may be used to identify the context (e.g., positive or negative, fraudulent or non-fraudulent, good or bad, etc.). The cascading system described herein may enhance the performance of traditional machine learning models. For example, traditional machine learning models may process data records and generate the corresponding predicted labels for the data records. The cascading system may implement a combined machine learning model which may consider multiple dimensional input data. The input data may include the original data records, the metadata related to the data records, the correlations of the data records, etc. As such, the combined machine learning model may process the data records to make more accurate and sophisticated predictions.

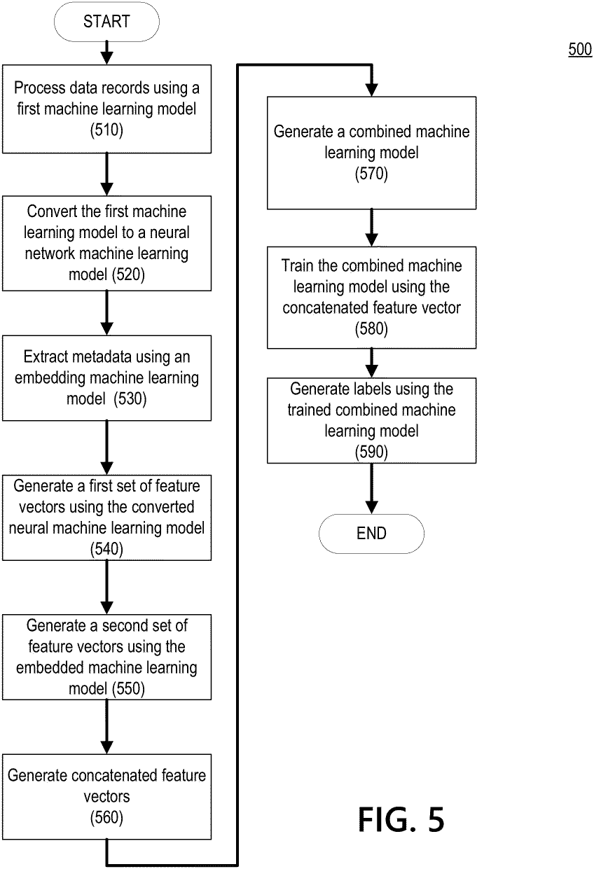

FIG. 5 shows a flow chart of a process 500 for cascading a meta learner to enhance the functionalities of machine learning models according to one or more aspects of the disclosure. Some or all of the steps of process 500 may be performed using one or more computing devices as described herein.

At step 510, a cascading server (e.g., cascading server 320) may process a plurality of data records using an existing machine learning model. The cascading server may receive data records comprising a collection of text from various input devices. The data records may be in a first data format, and the collection of text may represent a plurality of confidential data. For example, the cascading server may receive transaction records related to previously conducted transactions that may be labeled either as fraudulent or non-fraudulent. The transaction records may provide insights to facilitate credit decisioning and/or fraud detection logic. The transaction records may include confidential information such as an account identifier, a transaction amount, a transaction time, transaction location, a channel of transaction (e.g., online or in physical store) and a merchant identifier. In a variety of embodiments, the documents may be collected in an unstructured data format, such as text format and converted into a common format, such as a JSON format, CSV format, or an XML format.

The documents may be collected and processed in a data stream in real time. The collected documents may be processed in a batch process. For example, the documents containing confidential data may be collected periodically or the documents may be dumped periodically, such as once per 10 minutes, once per hour, or once per day. Confidential data in the text format may be pre-processed via a random sampling to eliminate duplicated data. Confidential data may be dumped after a verification of non-duplicated data to produce a light weight data payload.

The cascading server may pre-process the data records using natural language processing (NLP) or optical character recognition (OCR) to parse the documents and/or identify keywords. The cascading server may remove certain stop words that do not add much meaning to the sentences, such as “and,” “at,” “the,” “is,” “which,” etc.

The cascading server may provide the pre-processed data records to the existing machine learning model. The existing machine learning model may use data values recorded in the data records, for example, a transaction amount, to make predictions and generate predicted labels. The existing machine learning model may be a traditional machine learning model developed by an organization to process big data (e.g., transaction data) related to the business of the organization (e.g., a financial institution). For example, the existing machine learning model may include a decision tree machine learning model, which uses a decision tree as a predictive model, where the leaves represent class labels and branches represent conjunctions of features that lead to the class labels. The decision tree machine learning model may be simple to understand and need little data normalization. However, the decision tree machine learning model may suffer performance issues in certain circumstances. For example, a small change in the training data may result in a drastic change in the tree and the final prediction. The decision tree learners may create overly-complex trees that do not generalize well from the training data. In some examples, the existing machine learning model may include a neural network machine learning model. Due to the fact that the existing machine learning models may use data values in the data records to make predictions, their performance may be less optimal. The cascading server may use a combined machine learning model to improve the performance of the existing machine learning models.

At step 520, the cascading server may convert the existing machine learning model to a neural network machine learning model. Step 520 may be optional in the event that the existing machine learning model is a neural network machine learning model. The converted neural network machine learning model may have the deep neural network architecture 200 as illustrated in FIG. 2. The converted neural network machine learning model may include, for example, a FCNN, a CNN, a recurrent neural network, or a feed forward neural network. The cascading server may provide the same input into the existing machine learning model and the converted neural network machine learning model. The cascading server may receive the output comprising predicted labels from the existing machine learning model. The cascading server may use these output as ground truth for the converted neural network machine learning model. The cascading server may tune the converted neural network machine learning model to work as a proxy or an approximation of the existing machine learning model. The cascading server may change the architecture of the converted neural network machine learning model to have the best fit with the labels generated from the existing machine learning model.

For example, the existing machine learning model (e.g., a decision tree model) may have ten training data samples, with the first five samples having 0 label (e.g., non-fraudulent) and the last five samples having 1 label (e.g., fraudulent). The same training data samples may be used to train the converted neural network machine learning model. The converted neural network machine learning model may attempt to explore the relationships between the inputs and output, and the cascading server may use the converted neural network machine learning model to optimize that function. The converted neural network machine learning model may be tuned with a relative high confidence on the accuracy of the converted neural network machine learning model, so that it is an approximation to the existing machine learning model.

At step 530, the cascading server may extract metadata associated with the plurality of data records using an embedding machine learning model. The embedding machine learning model may include, for example, an autoencoder, a VAE, a Bert Model or a transformer model. The cascading server may convert the data records (e.g., document) to create the text embeddings, for example, based on the collection of text. The cascading server may convert the document from the first data format to a second data format to embed the plurality of confidential data in the document. The second data format may include text embeddings that are generated, for example, based on the collection of text. For example, the cascading server may use an autoencoder, such as a VAE to convert the documents. An autoencoder may be a type of artificial neural network used to learn efficient data coding in an unsupervised manner. The autoencoder may learn a representation (e.g., encoding) for a set of data for the purpose of dimensionality reduction by training the network to ignore signal “noise.” The autoencoder may have a reconstructing side, where the autoencoder may generate, from the reduced encoding, a representation which is a close approximation, if not an identical reproduction, of the original input. An embedding may be a compact representation of the original data and the compact representation may correspond to the metadata based on the original data. The cascading server may use language modeling and/or feature learning techniques in NLP where keywords or phrases from the collection of the text may be mapped to vectors of real numbers. In an example, where a document contains a comment comprising six sentences, the cascading server may convert each of the six sentences into a feature vector. For example, a first feature may be generated based on keywords in the first sentence. In some examples, the feature vector may be a ten-dimensional vector that maintain the features of the original data sample. Likewise, the cascading server may convert the second sentence in the comment into a second feature vector. In another example, where the document contains various transaction records, the document may include keywords related to a transaction, such as an account identifier, a transaction amount, a transaction time, transaction location, a channel of transaction (e.g., online or in physical store), a merchant identifier, a merchant code, etc. The cascading server may convert transaction-related information into text embeddings corresponding to one or more feature vectors. The one or more feature vectors may be based on the keywords related to the transaction.

The metadata may be based on the original data records. For example, the original data records may be converted into a second data format that contains structural data set, which may contain useful column names (e.g., account identifier, transaction amount, etc.) or table names indicating the data sources. Similarly, the table names or key names in JSON files may also contain the metadata. The existing machine learning model may rely on data values recorded in the data records, and do not take advantage of the metadata. For example, the existing machine learning model may not consider the column names, the data set name, location of the data source. On the other hand, the cascading server may incorporate these metadata information to increase the overall performance of the existing machine learning model without changing its internal structure or operation.

The explicit metadata such as a column name or a table name may be more readily extracted. The cascading server may employ the embedding machine learning model such as a data profiler to extract implicit metadata. For example, the data profiler may extract the statistics on the columns, such as a mean, a variance, a minimal value or maximal value, a standard deviation, a histogram, or a range or length associated with a column. The data profiler may extract summary information for each of the column and the correlations between the columns.

At step 540, the cascading server may generate a first set of feature vectors using the plurality of data records as input and via the converted neural network machine learning model. The cascading server may provide the data records as input to the converted neural network machine learning model. The cascading server may receive from the converted neural machine learning mode, the first set of feature vectors as output. For example, the first set of feature vectors may include a 200-dimension vector.

At step 550, the cascading server may generate a second set of feature vectors using the metadata as input and via the embedding machine learning model. The cascading server may provide the text representations of metadata as input to the embedding machine learning model. The cascading server may employ the embedding machine learning model such as a deep neural network machine learning model to extract features from the metadata. For example, similar to the process of using an autoencoder to generate embeddings from text data, the embedding machine learning model may generate a compact representation of an input vector of original text into, for example, a 100-dimension vector. The embedding machine learning model may attempt to reflect the original text feature vector, and compare the input vector of original text with the newly generated 100-dimension vector. The embedding machine learning model may attempt to minimize the loss and identify the best compact representation of the original feature vector. The embedding machine learning model (e.g., an autoencoder or a transformer) may be tuned to learn the relationships between the features.

At step 560, the cascading server may concatenate the first set of feature vectors with the second set of feature vectors to generate concatenated feature vectors. The cascading server may append two set of feature vectors together - the first set of feature vectors from the converted neural network model and the second set of feature vectors from the embedding machine learning model. Concatenation of feature vectors may be represented as:
Feature1 = [0.1, 0.2, 0.3, ...]
Feature2 = [0.5, 0.6, 0.7, ...]
[Feature1, feature2] = [0.1, 0.2, 0.3, ..., 0.5, 0.6, 0.7, ...]

For example, the first set of feature vectors may include a 200-dimension feature vector, and the second set of feature vectors include a 100-dimension feature vector. The concatenated feature vectors may include a 300-dimension feature vector.

At step 570, the cascading server may generate a combined machine learning model based on the neural network machine learning model and the embedding machine learning model. The combined machine learning model may be a logic model based on the fact that the combined machine learning model takes the concatenated feature vectors as input, while such input are combined from the feature vectors generated from the neural network machine learning model and the embedding machine learning model, respectively. The combined machine learning model may include an additional prediction layer or a classification layer to make predictions based on the concatenated feature vectors. In some examples, the additional prediction layer may be a fully connected network separating from the embedding machine learning model. Additionally or alternatively, the prediction layer or classification layer may be a component of a neural network, such as a generative adversarial network (GAN), or a consistent adversarial network (CAN), such as a cyclic generative adversarial network (C-GAN), a deep convolutional GAN (DC-GAN), GAN interpolation (GAN-INT), GAN-CLS, a cyclic-CAN (e.g., C-CAN), or any equivalent thereof.

At step 580, the cascading server may train the combined machine learning model using pre-defined concatenated feature vectors as input. The combined machine learning model, particularly the additional prediction layer or classification layer may be trained using supervised learning, unsupervised learning, back propagation, transfer learning, stochastic gradient descent, learning rate decay, dropout, max pooling, batch normalization, long short-term memory, skip-gram, or any equivalent deep learning technique.

An existing machine learning model may generate a plurality of prediction labels based on a plurality of data records. The cascading server may provide the concatenated feature vectors as input to a classification layer. The cascading server may receive a plurality of new prediction labels associated with the plurality of data records as output from the classification layer. The cascading server may compare the prediction labels generated from the existing machine leaning model with the new prediction labels generated by the combined machine learning model, and train the combined machine learning model based on the comparison.

In contrast with a conventional approach that may use the values of the data records as input to train an existing machine learning model, the combined machine learning model may be trained using multi-dimensional information, including the values of the data records and the metadata of the original data records. The trained combined machine learning model may improve the functionalities and performance of the existing machine model. For example, based on the metadata indicating the column names of the transaction record, the correlation between the transaction time and the merchant, or a range of a user’s transaction amounts, the trained combined machine learning model may determine whether the transaction fits into a spending pattern of a specific user. The trained combined machine learning model may be better adapted to determine whether the transaction is fraudulent. For example, a transaction record indicating a non-fraudulent transaction that occurs at regular hour, originated from a customer’s regular cell phone, and within a certain transaction amount may conform to the user’s spending pattern. In contrast, a transaction record indicating a fraudulent transaction that occurs at an irregular hour (e.g., 2:00 am in the customer’s time zone), originated from a transaction place that is thousand miles away from the customer’s home, and for a transaction amount much greater than the customer’s regular transaction amount may not conform to the user’s spending pattern.

At step 590, the cascading server may use the trained combined machine learning model to generate data labels for a new set of data records. The data labels generated by the trained combined machine learning model may highlight certain data features, which may be the properties, characteristics, or classifications of the data. The cascading server may store the labels with the original data in the annotation database. For example, the annotation database may have a first record including a first sentence in a comment from a customer regarding a service provided by the institution. The cascading server may store a first label associated with the first sentence in the first record. Likewise, the cascading server may store a second record including a second sentence in the comment with the second label. Annotation database may accordingly store six records corresponding to each of the six sentences in the comment, with the first three records all having positive labels (e.g., class 1) and the next three records all having negative labels (e.g., class 0). As such, the mappings between the labels to the particular portions or features of the original document may be stored in the annotation database. The stored documents and the corresponding labels may be later retrieved from the annotation database and used as inputs or training data to various machine learning models as needed.

The cascading server may retrieve the data record with the labels from the annotation database. The cascading server may send the data record to a computing device, such as a server that conducts credit decisioning for loan or credit card applications or fraud detecting logic for transaction processing.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, and the like that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid-state memory, RAM, and the like. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a system, and/or a computer program product.

Although the present invention has been described in certain specific aspects, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. It is therefore to be understood that the present invention may be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A computer-implemented method comprising:
processing a plurality of data records using a first machine learning model;
converting the first machine learning model to a neural network machine learning model;
extracting, using an embedding machine learning model, metadata associated with the plurality of data records;
generating, using the plurality of data records as input and via the converted neural network machine learning model, a first set of feature vectors;
generating, using the metadata as input and via the embedding machine learning model, a second set of feature vectors;
concatenating the first set of feature vectors with the second set of feature vectors to generate concatenated feature vectors;
generating, based on the neural network machine learning model and the embedding machine learning model, a combined machine learning model; and
training, using the concatenated feature vectors as input, the combined machine learning model, wherein the trained combined machine learning model enhances performance of the first machine learning model.

2. The computer-implemented method of claim 1, wherein the first machine learning model comprises a decision tree model, a standard normal variate (SNV) model, a support vector machine (SVM) model or a random forest model.

3. The computer-implemented method of claim 1, wherein the embedding machine learning model comprises an autoencoder, a variational autoencoder (VAE), a Bert Model or a transformer model.

4. The computer-implemented method of claim 1, wherein the converted neural network machine learning model comprises a fully connected neural network (FCNN), a convolutional neural network (CNN), a recurrent neural network, or a feed forward neural network.

5. The computer-implemented method of claim 1, wherein processing the plurality of data records comprises:
receiving the plurality of data records in a first data format;
converting the plurality of data records from the first data format to a second data format; and
generating, using the first machine learning model based on the plurality of data records in the second data format, a plurality of prediction labels.

6. The computer-implemented method of claim 5, wherein the plurality of data records comprise transaction records, and wherein the predicted labels comprise an indication whether the plurality of data records contain sensitive data.

7. The computer-implemented method of claim 1, wherein the metadata comprises column names, data sources, table names, and correlation between features that are associated with the plurality of data records.

8. The computer-implemented method of claim 1, wherein the metadata comprises a mean, a variance, a range or a length associated with a column in the plurality of data records.

9. The computer-implemented method of claim 1, further comprising:
training, based on the plurality of data records and prediction labels generated by the first machine learning model, the converted neural network machine learning model to be a proxy to the first machine learning model.

10. The computer-implemented method of claim 1, wherein training the combined machine learning model comprises:
receiving, as output from the first machine learning model and based on the plurality of data records, a plurality of prediction labels associated with the plurality of data records;
providing, as input to a classification layer, the concatenated feature vectors;
receiving, as output from the classification layer and based on the concatenated feature vectors, a plurality of new prediction labels associated with the plurality of data records;
comparing the plurality of prediction labels with the plurality of new prediction labels; and
training the combined machine learning model based on the comparison.

11. A computing device comprising:
one or more processors; and
memory storing instructions that, when executed by the one or more processors, cause the computing device to:
processing a plurality of data records using a first machine learning model;
convert the first machine learning model to a neural network machine learning model;
extract, using an embedding machine learning model, metadata associated with the plurality of data records;
generate, using the plurality of data records as input and via the converted neural network machine learning model, a first set of feature vectors;
generate, using the metadata as input and via the embedding machine learning model, a second set of feature vectors;
concatenate the first set of feature vectors with the second set of feature vectors to generate concatenated feature vectors;
generate, based on the neural network machine learning model and the embedding machine learning model, a combined machine learning model; and
train, using the concatenated feature vectors as input, the combined machine learning model, wherein the trained combined machine learning model enhances performance of the first machine learning model.

12. The computing device of claim 11, wherein the first machine learning model comprises a decision tree model, a standard normal variate (SNV) model, a support vector machine (SVM) model or a random forest model.

13. The computing device of claim 11, wherein the embedding machine learning model comprises an autoencoder, a VAE, a Bert Model or a transformer model.

14. The computing device of claim 11, wherein the converted neural network machine learning model comprises a FCNN or a CNN.

15. The computing device of claim 11, wherein the metadata comprises column names, data sources, table names, and correlation between features that are associated with the plurality of data records.

16. The computing device of claim 11, wherein the metadata comprises a mean, a variance, a range or a length associated with a column in the plurality of data records.

17. The computing device of claim 11, wherein the instructions when executed cause the computing device to:
train, based on the plurality of data records and prediction labels generated by the first machine learning model, the converted neural network machine learning model to approximate the first machine learning model.

18. The computing device of claim 11, wherein the instructions when executed further cause the computing device to:
receive, as output from the first machine learning model and based on the plurality of data records, a plurality of prediction labels associated with the plurality of data records;
provide, as input to a classification layer, the concatenated feature vectors;
receive, as output from the classification layer and based on the concatenated feature vectors, a plurality of new prediction labels associated with the plurality of data records;
compare the plurality of prediction labels with the plurality of new prediction labels; and
train the combined machine learning model based on the comparison.

19. One or more non-transitory media storing instructions that, when executed by one or more processors, cause the one or more processors to perform steps comprising:
processing a plurality of data records using a first machine learning model;
receiving, as output from the first machine learning model and based on the plurality of data records, a plurality of prediction labels associated with the plurality of data records;
converting the first machine learning model to a neural network machine learning model;
extracting, using an embedding machine learning model, metadata associated with the plurality of data records;
generating, using the plurality of data records as input and via the converted neural network machine learning model, a first set of feature vectors;
generating, using the metadata as input and via the embedding machine learning model, a second set of feature vectors;
concatenating the first set of feature vectors with the second set of feature vectors to generate concatenated feature vectors;
generating, based on the neural network machine learning model and the embedding machine learning model, a combined machine learning model;
providing, as input to a classification layer, the concatenated feature vectors;
receiving, as output from the classification layer and based on the concatenated feature vectors, a plurality of new prediction labels associated with the plurality of data records;
comparing the plurality of prediction labels with the plurality of new prediction labels; and
training the combined machine learning model based on the comparison, wherein the trained combined machine learning model enhances performance of the first machine learning model.

20. The non-transitory media of claim 19, wherein the metadata comprises a mean, a variance, a range or a length associated with a column in the plurality of data records, column names, data sources, table names, and correlation between features that are associated with the plurality of data records.
